(19) United States
(12) Patent Application Publication
(10) Pub. No.: US 2025/0290313 A1
(43) Pub. Date: Sep. 18, 2025

(54) MOUNTING ELEMENT FOR AN INSTALLATION OF A RUNNER RAIL IN A DRYWALL SYSTEM OF A SLIDING DOOR CONSTRUCTION AND METHOD FOR MOUNTING A RUNNER RAIL

(71) Applicant: KNAUF GIPS KG, Iphofen (DE)

(72) Inventors: Marc HAGEDORN, Warstein (DE); Benedict ZERFASS, Schwarzerden (DE)

(21) Appl. No.: 18/861,354

(22) PCT Filed: Nov. 15, 2022
(86) PCT No.: PCT/EP2022/025510

§ 371 Date: Oct. 29, 2024

(30) Foreign Application Priority Data
May 9, 2022 (WO) PCT/EP2022/000042

(51) Int. Cl. E04B 2/76; E04B 1/38; E06B 3/46

(52) U.S. Cl. CPC E04B 2/761; E06B 3/4654; E04B 2001/389

(57) ABSTRACT

A mounting element for an installation of a runner rail in a drywall system of a sliding door construction includes a mounting angle having a first angle section for attachment at an upright drywall stud and a second angle section for attachment at the runner rail, wherein the mounting element includes a bendable plate at the first angle section, the bendable plate being of a size and shape to be bendable around the upright drywall stud in a manner that a first plate portion is in contact with a flange portion of the upright drywall stud and a second plate portion is in contact with a web portion of the upright drywall stud.

The invention relates to a mounting element for an installation of a runner rail in a drywall system of a sliding door construction and a method for mounting a runner rail according to the respective independent claim.

Sliding doors are widely used in the field of drywall systems because of many improvements reached therewith, like additional space, easy installation and barrier free constructions.

When it comes to additional space they are extremely efficient since the space inside the wall in the door area can also be fully utilized. Sliding door systems are also often a preferred choice over wing doors as they provide an excellent finish and can be perfectly integrated into the drywall system.

A specific drywall system of a sliding door construction is a pocket drywall construction. Therein a runner rail, at which the door leaf is arranged in a sliding manner, is fixed to pocket profiles and to (standard) upright drywall studs. The runner rail is attached via mounting elements to pocket profiles at positions at which the door leaf moves into the drywall. To take different ceiling heights and door dimensions into account, the vertical arrangement of the runner rail via the mounting elements has always to be adjusted to the specific room requirements. After adjustment to the required vertical position, the runner rail is fixed at the ends to an upright drywall stud by means of an angled mounting element.

This installation is complicated as the mounting components for the pocket profile need to be adjusted while the mounting components at the end of the runner rail are not fixed anyhow. This is particularly disadvantageous because in many cases, the mounting components need to be adjusted precisely in a way that a horizontal orientation of the runner rail is ensured to prevent the door leaf from an uncontrolled movement.

In other cases, it is desired that the runner rail shall have an inclined alignment with a defined angle, for example to provide a self-closing sliding door construction. Then, the runner rail is not aligned perpendicular to the upright drywall studs, and accordingly, to provide a good contact between the back side of a mounting element and the web of the stud, it is possible to design the mounting element by having an angle other than 90° between its back side and the base section. However, such mounting elements are only suitable for one predefined angle. Alternatively, when using “standard” mounting elements having a right angle between the back section and the base section, there will be no full-surface contact between the back section of the mounting element and the web of the stud to which the runner rail will be attached, resulting in problems like canting, tilting and displacement.

The invention provides a solution to the afore mentioned problems by providing a mounting element for an installation of a runner rail in a drywall system of a sliding door construction and method for mounting a runner rail, which is specifically designed to allow for arranging the runner rail close to the final position without the use of screws or likewise fixing elements.

The invention comprises a mounting element for an installation of a runner rail in a drywall system of a sliding door construction. The mounting element comprises a mounting angle having a first angle section for attachment at an upright drywall stud and (arranged angled thereto) a second angle section for attachment at the runner rail. The mounting element comprises a (separate) bendable plate (fixed) at the first angle section. The bendable plate is of a size and shape to be bendable around the upright drywall stud in a manner that a first plate portion is in contact with a flange portion of the upright drywall stud and a second plate portion is in contact with a web portion of the upright drywall stud. Due to the bendable plate, the mounting element is specifically designed to be attached to the runner rail via the second angle section and to slidable contact the first angle section to the upright stud at two different surfaces. That contact allows to adjust the non-fixed mounting components precisely in a way that a horizontal orientation of the runner rail is ensured to prevent the door leaf from an uncontrolled movement.

According to a preferred aspect, the bendable plate is of a size and shape to be bendable around the upright drywall stud in a manner that a first plate portion is in contact with a first flange portion of the upright drywall stud, a second plate portion with a web portion of the upright drywall stud and a third plate portion with a second flange portion of the upright drywall stud. This allows to fix the runner rail at the upright drywall stud in a manner to prevent an uncontrolled falling out during the installation because of the first plate portion and the second plate portion are in contact at two opposite sides of the upright drywall stud.

The runner rail can be aligned in a precisely horizontally orientation. If such a design is desired, it is advantageous if the second plate portions are in direct contact with the web portion of the upright drywall studs.

Alternatively, the mounting element according to the invention allows a secure fixation of inclined runner rails to upright studs. Since the flanges of the mounting element embrace the stud, i.e. the flanges of the mounting element abut to the flanges of the stud, no problem arises anymore in cases where the back section—i.e. the second plate portion—of the mounting element is not in form-fit contact to the web of the stud. Accordingly, the runner rail can be installed in exact predefined angles.

In a further development of the mounting element according to the invention, a bending line is present between the first angle section (21) and the second angle section (22), to adjust the angle between these two parts. This is especially advantageous in cases where the runner rail shall be installed inclined, to provide a form-fit contact between the back section—i.e. the second plate portion—of the mounting element to the web of the stud, once the first flange portion and the third flange portion are in their position. A respective bending line may be a perforation, a carving, a line material weakening line or the like.

Another preferred aspect relates to that the bendable plate is fixed to the first angle section by means of clinching points. Clinching is a reliable economic way to connect metal sheets and profiles of different material thickness.

It is moreover preferred if the bendable plate is of a size and shape so as to protrude the first angle section at two opposite border edges. The bendable plate can be arranged to be symmetrical relative to the first angle section so as to protrude each of the opposite border edges by the same length.

Preferably, the bendable plate comprises at least one elongated perforation arranged parallel to the border edges. The elongated perforation provides a (weakened) bending line to respectively separate the first plate portion, the second plate portion and the third plate portion.

According to an advantageous aspect the bendable plate comprises at least two elongated perforations arranged one after the other and oriented with a respective long side (edge) along a line parallel to the border edges. That allows to have openings at the most part of the intersection line between adjacent plate portions to make them easily bendable.

According to another advantageous aspect, the bendable plate comprises at least two pairs of at least two elongated perforations arranged one after the other with a respective long side along a line parallel to each border edge. That allows to cover two preferred sizes for the upright drywall stud, i.e. 75 mm or 100 mm.

Preferably, the bendable plate is a metal sheet. The metal sheet can be of a thickness in the range of 0.5 mm to 1.5 mm.

It is further preferred that the bendable plate is a metal sheet of thickness thinner than the thickness of the first angle section. That allows to provide mechanically a strong first angle section and a mechanically less strong bendable plate.

Advantageously, the bendable plate comprises a through opening of a size and shape to view at a marking element arranged at the upright drywall stud. The through opening can be of a square shape with a side length in the range of 5 to 15 mm.

Another aspect of the invention relates to a method for mounting a runner rail in a drywall system of a sliding door construction comprising the steps of
arranging a mounting element with a bendable plate at an upright drywall stud;
bending the bendable plate around (portions of) the upright drywall stud;
vertically positioning the mounting element (by a sliding movement); and
fixing the mounting element to the upright drywall stud (by means of fixing element, like screws).

A preferred aspect of the invention relates to that the mounting element is a mounting element as described herein.

Advantageously, the step of bending the bendable plate around the upright drywall stud comprises a first bending step of bending a first plate portion to be in contact with a first flange portion of the upright drywall stud before the mounting element is arranged at the upright drywall stud and a second bending step of bending a third plate portion to be in contact with a second flange portion of the upright drywall stud after the mounting element is arranged at the upright drywall stud.

In cases where a mounting element comprising a bending line between the first angle section and the second angle section is used, especially when a runner rail shall be installed in an inclined alignment, a step of bending to achieve a suitable angle between the first angle section and the second angle section may be optionally inserted.

Once the mounting element is finally fixed to the stud, the first plate portion and/or the third plate portion may be completely removed, e.g. by breaking off, clipping off or cutting off, especially along the elongated perforations that were used for bending before.

In the following, the invention is described in connection to the drawings, where:

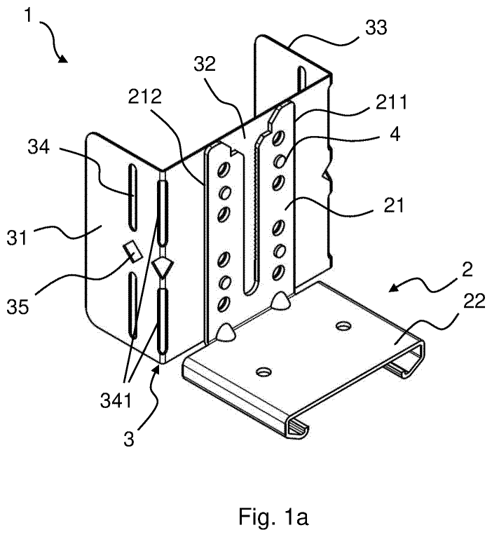

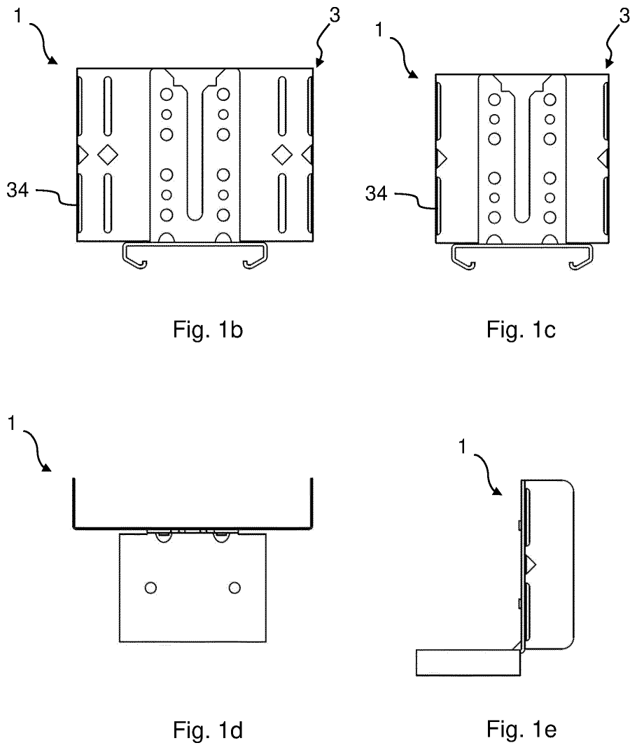

FIGS. 1a-1e are different views on a schematic drawing of a mounting element according to an embodiment of the invention;

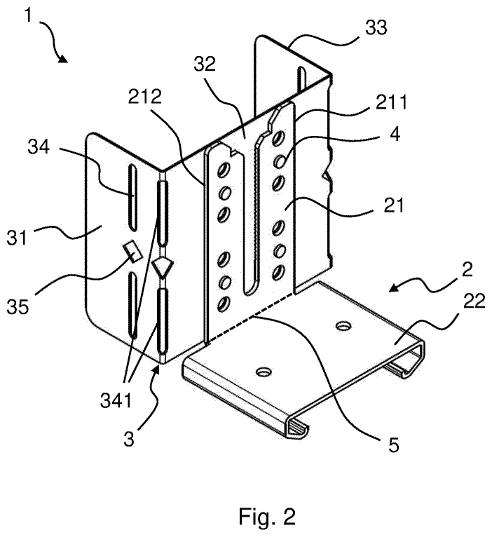

FIG. 2 shows a further embodiment of a mounting element according to the invention;

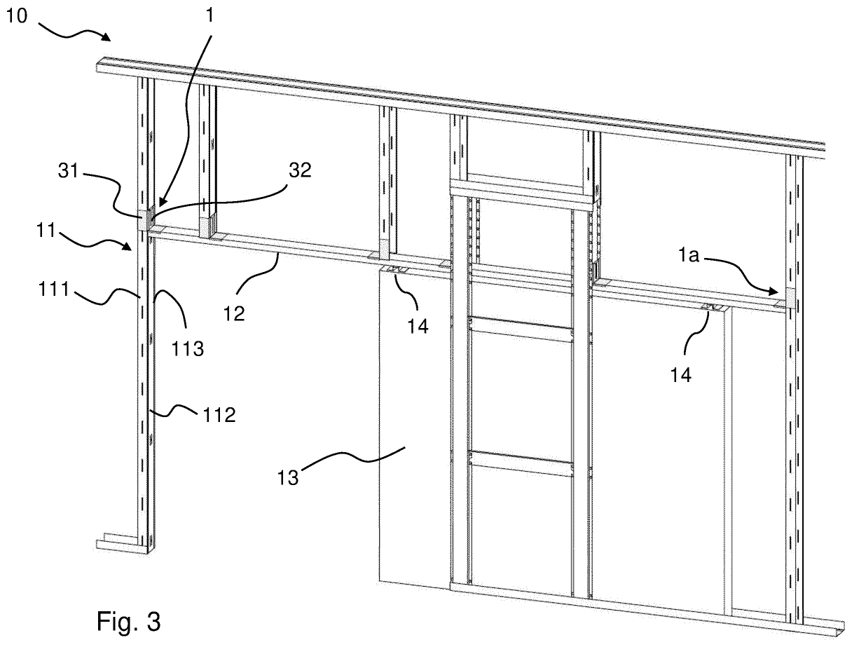

FIG. 3 shows a drywall system of a sliding door construction with a runner rail fixed with the mounting element shown in FIGS. 1a to 1e, wherein the runner rail is aligned horizontally; and

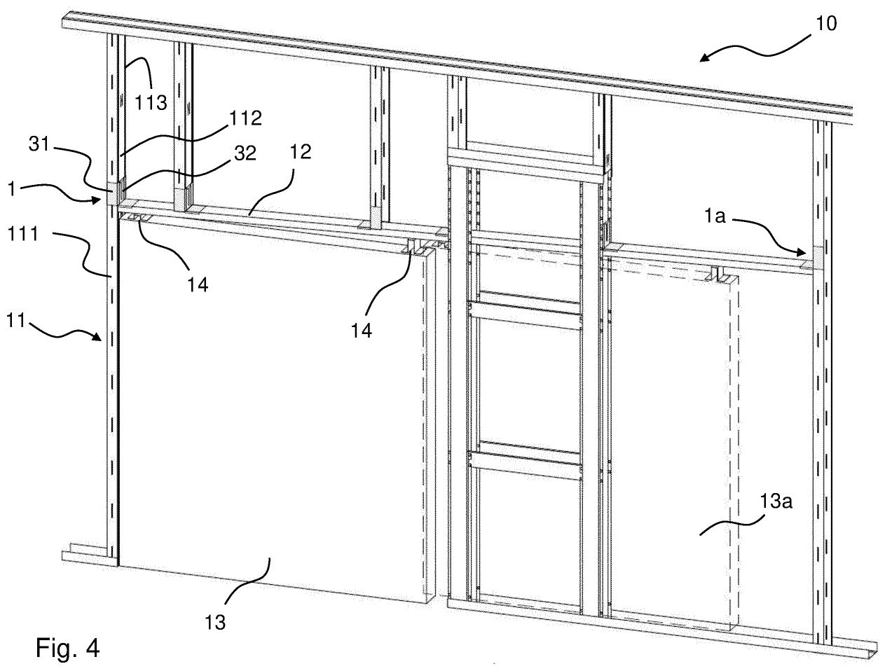

FIG. 4 shows a drywall system of a sliding door construction with a runner rail fixed with the mounting element shown in FIGS. 1a to 1e, wherein the runner rail is aligned inclined.

FIG. 1a shows a mounting element 1 for an installation of a runner rail 12 in a drywall system of a sliding door construction 10. The mounting angle 2 has a first angle section 21 for attachment at an upright drywall stud (11, see FIG. 3) and a second angle section 22 for attachment at the runner rail (12, see FIG. 3) to connect the runner rail to the upright drywall stud.

The mounting element 1 comprises a bendable plate 3 at the first angle section 21, the bendable plate 3 being of a size and shape to be bendable around the upright drywall stud in a manner that a first plate portion 31 is in contact with a flange portion (111, see FIG. 3 and FIG. 4) of the upright drywall stud and a second plate portion 32 is in contact with a web portion (112, see FIG. 3 and FIG. 4) of the upright drywall stud. Due to the bendable plate 3, the mounting element 1 is specifically designed to be attached to the runner rail via the second angle section 22 and to slidable contact the first angle section 21 to the upright stud at two different surfaces.

That contact allows to adjust the non-fixed mounting components precisely in a way that a horizontal orientation of the runner rail is ensured to prevent the door leaf (13) from an uncontrolled movement (see FIG. 3). However, alternatively, that contact also allows to adjust the non-fixed mounting components precisely in a way that an inclined alignment of the runner rail at desired angles is realized (see FIG. 4). Thus, the door leaf 13 automatically will return from any open state 13a (dotted lines) into the close state (shown position of door leaf 13, solid lines) once it is released from any retention forces. Due to suspension devices 14 having different lengths adapted to the inclination of the runner rail, the door leaf 13 itself is permanently aligned horizontally. Of course, it is also possible to install self-opening sliding doors by aligning the runner rail in the inverted direction, i.e. such that the door leaf is lower in the open position (not shown in the figures).

To exactly adjust the inclination of the runner rail, it is advantageous if at least also the fixation of the other end 1a of the runner rail 12 at the respective stud is effected by a mounting element according to the invention (see FIG. 3 and FIG. 4).

The bendable plate 3 is fixed to the first angle section 21 via four clinching points 4 which are arranged square.

The bendable plate 3 symmetrically protrudes the first angle section 21 to the left and right (not over the top) over both parallel border edges 211, 212 for the same length.

The bendable plate 3 comprises on each side of the first angle section 21 two parallel pairs of two elongated perforations 34 arranged in one vertical line one after the other. Both perforations are arranged along a line, wherein each has a respective long side 341 parallel to the respective border edge 211. Each of the parallel pair of elongated perforations 34 corresponds to a typical width of the web portion for the upright drywall stud.

In the shown example, the bendable plate 3 is a metal sheet. The bendable plate 3 is a metal sheet of thickness thinner than the thickness of the first angle section 21. The bendable plate has a surface area three to four times the surface area of the first angle portion 34.

The bendable plate 3 comprises four through openings 35 through which a marking element arranged at the upright drywall stud 11 can be seen for adjusting the height or position of the mounting element at the upright stud.

FIG. 1b is a frontal view of the mounting element 1 of FIG. 1a, wherein the bendable plate 3 is bend at outer two lines of elongated perforations 34 which correspond for example to a width of the web portion of the upright drywall stud of 100 mm (not shown).

FIG. 1c is a frontal view of the mounting element of FIG. 1a, wherein the bendable plate 3 is bend at two lines of elongated perforations 34 which correspond to a width of the web portion of the upright drywall stud of 75 mm (not shown).

FIG. 1d is a top view of the mounting element 1 of FIG. 1b.

FIG. 1e is a side view of the mounting element 1 of FIG. 1c.

FIG. 2 shows a mounting element in accordance to FIG. 1, but with a bending line 5 as an additional feature, to adjust the angle between the first angle section 21 and the second angle section 22.

In FIG. 3 is illustrated a drywall system of a sliding door construction 10 with a horizontally aligned runner rail 12 fixed by the mounting element of FIGS. 1a to 1e and without building panels mounted thereon.

In FIG. 4 is illustrated a drywall system of a sliding door construction 10 with an inclined runner rail 12 fixed by the mounting element of FIGS. 1a to 2 and without building panels mounted thereon.

In FIG. 3 and FIG. 4 two mounting elements 1 are shown on the upper side of the runner rail 12 at the outer position bordering of the sliding door construction 10. The angle is fixed with a first angle section at the upright drywall stud 11 and with the second angle section at the runner rail 12.

The mounting element 1 comprises a bendable plate 3 at the first angle section, the bendable plate 3 being of a size and shape to be bendable around the upright drywall stud in a manner that a first plate portion 31 is in contact with a flange portion 111 (which can be seen) of the upright drywall stud 11 and a second plate portion is in contact with a web portion 112 of the upright drywall 11 stud. The third plate portion (not shown) is in contact with a second flange portion 113 (which can only be partly seen) of the upright drywall stud 11.

For mounting the runner rail 12 in the shown drywall system of a sliding door construction 10, at first, a mounting element 1 is arranged with a bendable plate (3, see FIG. 1) at a upright drywall stud 11.

Thereafter the a bendable plate is bend around the upright drywall stud 11, wherein the step of bending the bendable plate around the upright drywall stud 11 comprises a first bending step of bending a first plate portion (31, see FIG. 1) to be in contact with the first flange portion 111 of the upright drywall stud 11 before the mounting element is arranged at the upright drywall stud 11 and a second bending step of bending a third plate portion (33, see FIG. 1) with a second flange portion 113 of the upright drywall stud 11.

Thereafter, the mounting element 1 is vertically positioned at the upright stud 11.

Finally, the mounting element 1 is fixed to the upright drywall stud 11, e.g. by means of screws.

1. A mounting element for an installation of a runner rail in a drywall system of a sliding door construction comprising: a mounting angle having a first angle section for attachment at an upright drywall stud and a second angle section for attachment at the runner rail;
wherein the mounting element comprises a bendable plate at the first angle section; the bendable plate being of a size and shape to be bendable around the upright drywall stud in a manner that a first plate portion is in contact with a flange portion of the upright drywall stud; and a second plate portion is in contact with a web portion of the upright drywall stud.

2. The mounting element according to claim 1, wherein the bendable plate is of a size and shape to be bendable around the upright drywall stud in a manner that a first plate portion is in contact with a first flange portion of the upright drywall stud, a second plate portion with a web portion of the upright drywall stud and a third plate portion with a second flange portion of the upright drywall stud.

3. The mounting element according to claim 1, wherein the bendable plate is fixed to the first angle section by means of clinching points.

4. The mounting element according to claim 1, wherein the bendable plate is of a size and shape so as to protrude the first angle section at two opposite border edges.

5. The mounting element according claim 4, wherein the bendable plate comprises at least one elongated perforation arranged parallel to the border edges.

6. The mounting element according claim 5, wherein the bendable plate comprises at least two elongated perforations arranged one after the other and oriented with a respective long side along a line parallel to the border edges.

7. The mounting element according claim 6, wherein the bendable plate comprises at least two pairs of at least two elongated perforations arranged one after the other with a respective long side along a line parallel to each border edge.

8. The mounting element according to claim 1, wherein the bendable plate is a metal sheet.

9. The mounting element according to claim 1, wherein the bendable plate is a metal sheet of thickness thinner than the thickness of the first angle section.

10. The mounting element according to claim 1, wherein the bendable plate comprises a through opening of a size and shape to view at a marking element arranged at the upright drywall stud.

11. The mounting element according to claim 1, wherein between the first angle section and the second angle section there is a bending line.

12. A method for mounting a runner rail in a drywall system of a sliding door construction comprising the steps of:
arranging a mounting element with a bendable plate at an upright drywall stud;
bending the a bendable plate around the upright drywall stud;
vertically positioning the a mounting element; and
fixing the mounting element to the upright drywall stud.

13. The method according to claim 12, wherein the mounting element is a mounting element, comprising a mounting angle having a first angle section for attachment at an upright drywall stud and a second angle section for attachment at the runner rail;
wherein the mounting element comprises a bendable plate at the first angle section;
the bendable plate being of a size and shape to be bendable around the upright drywall stud in a manner that a first plate portion is in contact with a flange portion of the upright drywall stud; and a second plate portion is in contact with a web portion of the upright drywall stud.

14. The method according to claim 12, wherein the step of bending the bendable plate around the upright drywall stud comprises a first bending step of bending a first plate portion to be in contact with a first flange portion of the upright drywall stud before the mounting element is arranged at the upright drywall stud and a second bending step of bending a third plate portion to be in contact with a second flange portion of the upright drywall stud after the mounting element is arranged at the upright drywall stud.
